(19) United States
(12) Patent Application Publication
(10) Pub. No.: US 2009/0231967 A1
(43) Pub. Date: Sep. 17, 2009

(54) RENDERING PRE-RECORDED AND ADDITIONAL CONTENT

(75) Inventors: Philip Steven Newton, Eindhoven (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,952

(22) PCT Filed: Aug. 24, 2005
(86) PCT No.: PCT/IB05/52775

§ 371 Date: Feb. 20, 2007

(30) Foreign Application Priority Data
Aug. 30, 2004 (EP) 04104151.8

(51) Int. Cl. G11B 5/09

(52) U.S. Cl. 369/47.15; G9B/5.033

(57) ABSTRACT

A system includes a first storage 223 for storing data associated with the same content stored in a pre-recorded area of a plurality of record carriers, such as DVDs. A second storage is used to associate data in the first storage with a code. A reading device 231 includes means 433 for receiving a record carrier including a pre-recorded area and a write once area, means 436 for reading content stored in the pre-recorded area for rendering, means 435 for reading a code stored in the write-once area, and means 434 for accessing data stored in the first storage. The system verifies whether the read code corresponds to a code associated with data in the first storage and grants the reading device access to data stored in the first storage only upon a positive verification.

### FIELD OF THE INVENTION

The invention relates to a system for rendering content pre-recorded on a record carrier and for accessing associated data. The invention further relates to a reading device for use in the system. The invention also relates to a method of making content pre-recorded on a record carrier and associated data available.

### BACKGROUND OF THE INVENTION

New forms of consumer electronics products are continually being developed. Many efforts have focused on the convergence of computer technology and home entertainment systems. Important areas are interactive applications and enhanced functionality, for example, by making content retrieved from the Internet available in addition to locally available content. eDVD is such a technology in which a Digital Versatile Disc or Digital Video Disc (DVD) disc is linked to web content of a website, wherein the web content is directly related to the content on the DVD disc. The content on the DVD may include video and audio content. eDVD provides fast access to high-quality video and audio data offered by DVD along with advantages offered by internet technology (e.g. interactivity, dynamic updates, etc.). For example, eDVD enables a local DVD to be enhanced with HTML web pages. WO 00/63915 describes such a eDVD system that integrates a WWW web browser into a DVD rendering apparatus. Uniform Resource Locator (URL) information corresponding to information on sites accessible by the browser is stored in fields within the DVD data. When the user actuates a DVD element that has such a corresponding URL link, the web browser displays the information pointed to from that site. When the user actuates a HTML menu or other browser-implemented feature, the DVD system accesses a portion of the DVD data specified in the menu. This arrangement provides two-way communication, i.e. HTML in the browser is able to control DVD content, and vice versa. Having a link between the web information and the DVD content makes it possible to present web content synchronously with the rendering of DVD information. The browser in the DVD player may be based on a conventional web browser. The web content is stored in a server accessible through the Internet.

In the known system, the DVD with the conventional content, such as audio and video, and the URLs to the additional content are pre-recorded in a conventional manufacturing process.

### OBJECT AND SUMMARY OF THE INVENTION

It is an object of the invention to provide a more flexible system and method.

To achieve the object of the invention, a system for rendering content pre-recorded on a record carrier and for accessing associated data includes:

a first storage for storing data associated with the same content stored in a pre-recorded area of a plurality of record carriers;

a second storage for associating data stored in the first storage with at least one code;

a reading device including: means for receiving a record carrier including a pre-recorded area and a write-once area, means for reading content stored in the pre-recorded area of the received record carrier for rendering; means for reading a code stored in the write-once area of the received record carrier; and means for accessing data stored in the first storage;

the system, based on information stored in the second storage, being operative to verify whether the read code corresponds to a code associated with data in the first storage and to grant the reading device access to data stored in the first storage only upon a positive verification.

According to the invention, a write-once area on the record carrier is used in addition to the pre-recorded content. Using a write-once area provides flexibility. It allows production of relatively small batches (even a single copy) with the same pre-recorded content as the entire batch but with a batch-specific content in the write-once area. Content/data in a first storage (e.g. on a web server) can be accessed in addition to the pre-recorded content. According to the invention, the write-once area is used for storing a code that allows verification whether access should be granted to the content/data in the first storage. A second storage is used for storing authorized links between the code and the additional data/content. The second storage may be combined with the first storage. The code may be small so that writing of the code can be performed fast, keeping production costs low. By using two separate areas on the record carrier, illegal home-copying is hindered. Conventional home-equipment is targeted towards writing conventional content and usually has no provision for writing special areas of a record carrier. The verification process based on the code written on the record carrier and the verification data in the second storage makes it possible to revoke illegal copies, if they were to appear anyhow.

According to the measure defined in dependent claim 2, the first storage is accessible through a wide area network, such as the Internet. In a preferred embodiment as defined in dependent claim 3, the code identifies the storage device and/or data in the storage device. This makes the system very user-friendly: the user does not need to specify the location. Unlike the known system where the location is prerecorded, the supplier of the disc now has much more freedom in changing the location. For example, if the supplier is a rental company, it can choose a website per title, per type of customer (e.g. with or without entitlement to certain additional content), etc. The rental company may also easily revoke a record carrier if it suspects misuse by not renting out a record carrier with a code that may have been copied illegally.

In an alternative embodiment as defined in dependent claim 4, the system includes an interface for receiving such an identification. Such an interface may be a user interface enabling a user to specify the identification. It may also be another suitable interface, such as an interface for receiving a smart-card with such an identification on it.

As defined in dependent claim 5, the identification preferably represents a URL or IP address.

According to the measure defined in dependent claim 6, the code is unique for the supplier of the record carrier. The supplier may be, for example, the company that sells or rents out the record carrier. By having a code that is unique for the supplier, the supplier can provide his customers with additional services that are not available to customers of a competitor. It will be appreciated that a supplier may use several codes that are not used by other suppliers. For example, a supplier may use a code per title of the record carrier.

According to the measure defined in dependent claim 7, the code is unique per record carrier. In this way, security can be increased (e.g. individual record carriers can be revoked with respect to access to the additional data/content) and/or user-specific services/data can be made available.

According to the measure defined in dependent claim 8, a program for performing the verification is already included in the pre-recorded area of the record carrier. This is a simple and cheap way of equipping the reader device with software for performing the verification. Moreover, the verification program can be changed per title of the record carrier.

The application program is preferably written for a virtual machine, such as the Java virtual machine, so as to be more platform-independent.

According to the measure defined in dependent claim 9, a database can be accessed with user-specific data. The code on the record carrier provides a basic authentication complemented by user data, such as a name and/or password and/or account number.

According to the measure defined in dependent claim 10, the user can set a parental control level. This is checked against a level stored for the additional data/content, such that it can be guaranteed that only additional content/data is made available that is appropriate in view of the level set by the user.

According to the measure defined in dependent claim 11, the record carrier is an optical storage medium, such as a DVD or Blu-Ray disc. Such record carriers are very suitable for distribution of high-quality audio and/or video. For DVD-ROM and BD-ROM, a Burst Cutting Area (BCA) has been defined/proposed. It is preferred to use this area for verifiable access to additional content/data according to the invention since professional machines are available to write the code and since there are consumer players that are able to read the code (but conventional consumer recorders will not be able to copy the code).

To achieve the object of the invention, a method of rendering content pre-recorded on a record carrier and of accessing data in a first storage, which data is associated with the pre-recorded content, comprises the steps of:

reading content stored in a pre-recorded area of a record carrier for rendering;

reading a code stored in a write-once area of the record carrier; and

verifying whether the read code corresponds to a code associated with data in the first storage and granting access to data stored in the first storage only upon a positive verification.

These and other aspects of the invention are apparent from and will be elucidated with reference to the embodiments described hereinafter.

### BRIEF DESCRIPTION OF THE DRAWINGS

In the drawings:

FIG. 1 shows a record carrier with a disc-specific area,

FIG. 2 shows a DVD disc with a Burst Cutting Area,

FIG. 3 is a schematic representation of the system according to the invention,

FIG. 4 shows and embodiment of a reading device according to the invention, and

FIG. 5 schematically shows the process of visiting a website in the system according to the invention, where the content of the website depends on a bar code on the BCA.

### DESCRIPTION OF EMBODIMENTS

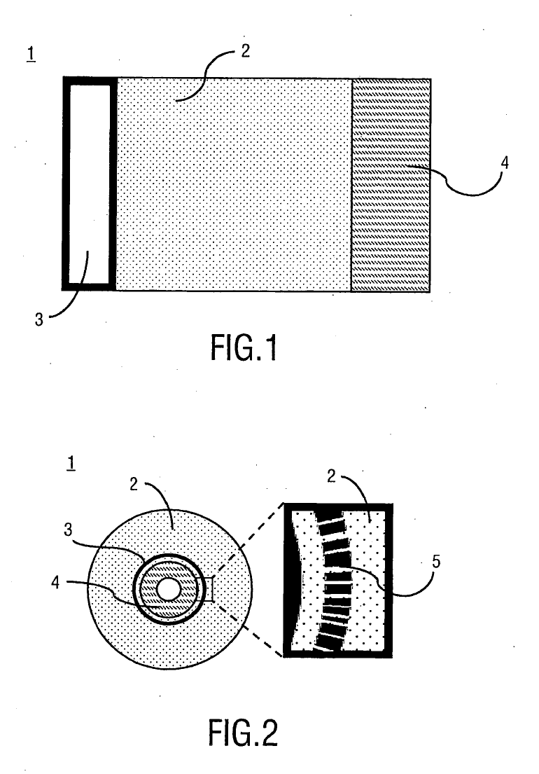

FIG. 1 shows a record carrier 1 including a data area 2 for storing content. The content may be stored optically, as in CDs, DVDs and Blu-Ray Discs (BD), magnetically, as in banking cards or on chip, as in Flash Memory and other types of ROM for, e.g. game computer cartridges. Other suitable forms of non-volatile memories may also be employed. The content may comprise video, audio, interactive computer programs, games or combinations of these. If desired, a part of the data area 2 is not pre-recorded but arranged to enable a user to store information, as in CD-Rs or memory sticks. For cost efficiency, preferably large volumes of identical record carriers are produced, in which case the data areas 2 of all record carriers are of a pre-recorded type, comprising the same content, such as a movie picture, a video game or a music album.

Additional to the data area 2, the record carrier 1 according to the invention comprises a write-once area 3. Data can be written on the write-once area 3 before or after mass-production of the record carrier in a separate writing process. The data on the write-once area may represent all sorts of information. For example, each copy of the record carrier 1 may comprise a unique identification number, which may be used for decrypting copy-protected content on the data area 2 or a serial number for allowing future retrieval of information concerning the production of the record carrier 1. On the record carrier according to the invention, the write-once area 3 is provided with a code for verifiable/authorized access to additional content/data. The code may be applied in many suitable ways, for example, optically, magnetically or on chip. The code may be realized, for example, as a series of numbers or other characters or as a bar code.

The record carrier may also comprise one or more additional areas 4 for additional functions, such as storing some specific data, comprising visual information or shaping the mechanical structure of the record carrier 1. These areas are not part of the invention and will not be further described here.

FIG. 2 shows an embodiment of the record carrier 1 according to the invention. In this embodiment, the record carrier 1 is a DVD, but similar embodiments for other optical storage media, such as CDs (Compact Disc) or BDs (Blu-ray Disc), can be realized. DVDs optionally comprise a Burst Cutting Area (BCA) on which additional information such as serial numbers may be written. The BCA is perfectly suited to serve as a write-once area 3 for holding the code according to the invention. The DVD 1 is an optical storage medium for storing digital content such as audio and/or video data. The DVD 1 may also comprise computer programs for enabling user interactivity. Such programs are preferably written for execution on a virtual machine, such as the Java virtual machine. Such computer programs may simply enable a user to choose an arbitrary playback sequence of the audio and video or may even be fully interactive computer games. The data is stored on the data area 2 of the DVD 1.

The BCA 3 may be situated inside the data area 2. For example, the BCA 3 may be an annular area inside the data area 2, near the center of the DVD 1, where a bar code 5 may be written for additional information. Alternatively the BCA 3 may be situated outside the data area 2 or in between two separate data areas. The bar code 5 may be written during mastering and will then be common for all discs from that master, or it may be written into the aluminum reflective layer of the DVD 1 after mastering. Other techniques for writing the bar code on the disc, such as printing, may be used. If the bar code 5 is not yet applied to the disc during the mastering process, optical discs can be given unique bar codes 5. The data stored in the BCA 3 of a standard DVD 1 may be four data units each consisting of 16 bytes, but the BCA 3 may comprise other amounts of data in other optical media.

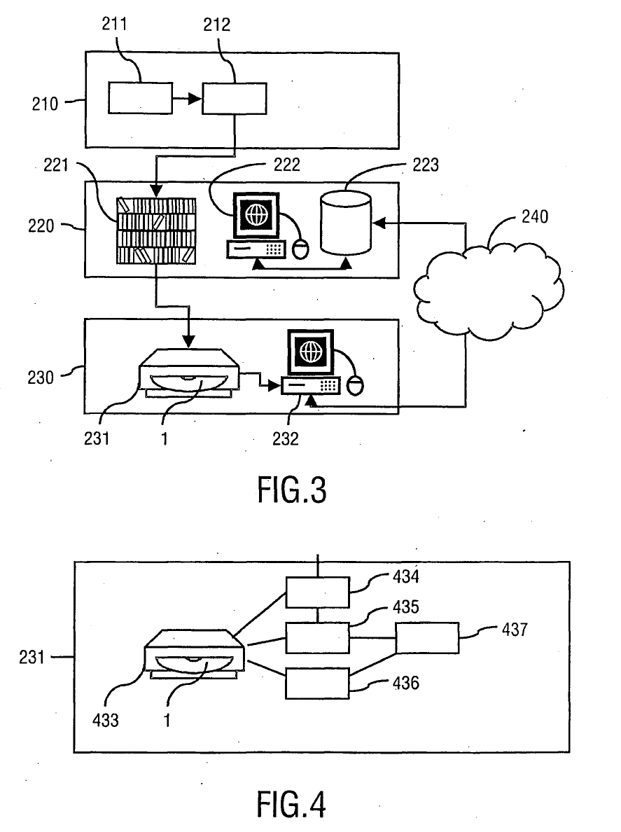

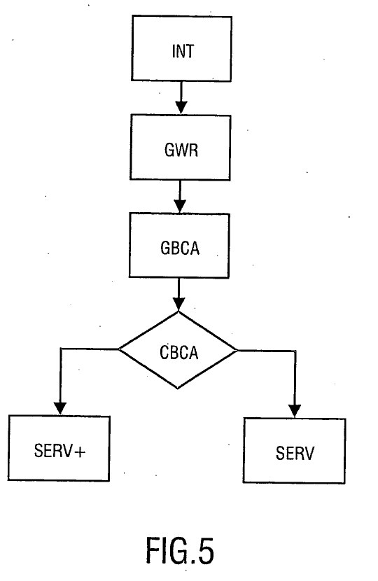

According to the invention, additional data that is associated with the content stored in a pre-recorded area 2 of a plurality of record carriers is stored in a first storage. All of these record carriers store at least some of the same data to which the additional data in the first storage is related. The first storage is preferably located in a server device accessible through a wide area network, such as the Internet. FIG. 3 shows such a server device 223. It will be appreciated that the invention may also be used for other forms of storage/storage devices. For example, the additional data/content may be supplied on a further pre-recorded record carrier. The remainder will focus on a system in which the first storage is located in a server accessible through the Internet. According to the invention, the system includes a second storage for associating data stored in the first storage with at least one code. The second storage may be combined with the first storage, in which case it is very simple to establish an association between the data in the first storage and the code or codes. The system further includes a reading device 231. FIG. 4 shows further details of an example of a reading device. The reading device 231 includes means 433 for receiving a record carrier 1 as described above. It will be understood that such receiving means are specific for the type of media used. For example, an optical drive with a tray is typically used for an optical storage medium. Other suitable reception means should be used for other media. The reading device 231 also has means 436 for reading content stored in the pre-recorded area of the received record carrier for rendering. Again, such means are well-known and will not be further described here. Furthermore, the reading device 231 has means 435 for reading the code stored in the write-once area of the received record carrier 1. Suitable means for reading such codes fall within the skills of a skilled person and have already been defined for optical storage media. According to the invention, the reading device also includes means 434 for accessing data stored in the first storage. Again, the exact details depend on the type of first storage and the location of the first storage. For example, if the first storage is located in a web server, the reading device 231 includes suitable hardware and/or software for accessing the Internet. The reading device 231 may have direct access to the Internet or through one or more intermediate devices, such as a gateway/router or a personal computer. Such techniques are well-known.

According to the invention, the system is operative to verify whether the code read by the reading device corresponds to a code associated with data in the first storage. The verification process uses information stored in the second storage. This information links the data in the first storage to one or more codes (e.g. using a table or other suitable linking mechanism). The verification may be done in a suitable device in the system. In an embodiment, the verification is done in the device that has the second storage. For example, if the second storage is also located in the same storage device 223 as that which includes the first storage (e.g. in the same web server), the verification may be performed in the web server. In this case, the reading device 231 supplies the read code to the storage device 223, that verifies the code by comparing it with the code or codes stored in the second storage. The reading device may use the same hardware/software as used by means 434 for communication to the storage device 223. In an alternative embodiment, the verification is at least partly done in the reading device 231 using means 437. In this case, the reading device 231 reads data from the second storage to be able to do the testing. It may read such data in any suitable way, for example, also through a network (e.g. using means 434). The pre-recorded area 2 of the record carrier 1 preferably includes an application program executable by the reading device 231 for performing the verification whether the read code corresponds to a code associated with data in the first storage. Such a program may be written in Java or another suitable language. According to the invention, the system grants the reading device access to data stored in the first storage only upon a positive verification. The code stored in the physically removable record carrier according to the invention thus acts as a form of authentication.

The code itself may have any suitable format and may represent various types of information. The code is preferably associated with a supplier of the record carrier, such as a retail company or rental company. It is preferred that the code includes one or more of the following identifications:
1. an identification of a location in the network of the storage device and/or the data in the storage device. A preferred way of doing this is to represent a universal resource locator (URL) and/or IP address.
2. a supplier code that is distinct for respective suppliers of the record carrier. Such a code would be the same for record carriers with the same pre-recorded content and supplied by the same supplier. A supplier may, but does not need to use different codes for record carriers with different content (titles).
3. a unique identification of the record carrier. It should be noted that this option is a special case of option 2, where different codes are issued even for carriers with the same content. In such a case, a specific successive range of identifications is preferably assigned to each supplier, thus simplifying the verification whether the record carrier was supplied by that supplier.
   If, for a network-based storage, the identification of the network location is not in the code, such a location may be specified in any other suitable way, e.g. by the reading device having a user interface that enables a user to specify the location or by reading it from a storage, such as a smart card.

If the code solely represents the storage location in a network, the mere fact that the reading device is thus able to locate the server would normally not be a sufficient authentication. The second storage would store the network location (e.g. URL) and an explicit test would be done by comparing the read code against this location stored in the second storage so as to prevent a device without an authentic record carrier from accessing the data simply by specifying the network location.

In an embodiment according to the invention, a supplier orders a number of record carriers 1, comprising certain content, such as a particular movie picture, a video game or a music album and provides each record carrier-specific area 3 of the record carriers 1 with a code associated with the supplier. The manufacturer may also write such a code in the write-once area 3 before delivering the record carriers 1 to the retailer or rental chain. The code allows authentication of a record carrier 1 as originating from a specific retailer or rental chain. While playing back the data content of the record carrier 1, the code may be used for linking to a specific website, showing a specific advertisement or allowing playback of data, which is only available for customers of a certain retailer or rental chain. Other applications may benefit from the same principle.

FIG. 3 schematically shows the system according to the invention. The system comprises a manufacturer 210 of the record carriers (in this example, optical discs), a rental chain or retailer 220 for renting and/or selling optical discs 1 and a customer 230, who rents optical discs 1 for use with a record carrier player 231 (in this example, an optical disc player). The manufacturer 210 uses at least two machines for manufacturing the optical disc 1, but these two machines may be integrated in one multi-purpose machine. The first machine 211 produces the optical disc 1 provided with audio and/or video data and/or computer programs stored on the pre-recorded area 2. A second BCA writing machine 212 writes a bar code 5 on the BCA 3. The BCA 3 is usually written by a very powerful laser (YAG or CO2) that burns and darkens the aluminum or other reflective metal layer in the center of the optical disc 1. These marks have a decreased reflectivity. Optical disc player 231 reads the BCA 3, e.g. by rotating at a constant angular velocity (1440 rpm), moving the optical pickup to the BCA 3, focusing on the information surface, and using a decoding circuit. In the system according to the invention, the BCA 3 is used to write a bar code 5 to the disc 1 that identifies that the disc 1 comes from a particular rental chain or retailer 220. The bar code 5 is a unique code identifying the rental chain or retailer 220. The bar code 5 may be, for example, a uniform resource locator (URL) or IP address, directly linking to a website on the Internet 240. The BCA 3 does not necessarily have to be written by the manufacturer 210. The BCA writing machine 212 may alternatively be owned and operated by the rental chain or retailer 220.

The rental chain or retailer 220 comprises shops (not shown) with shelves 221 full of optical discs 1. Customers 230 can enter the shops and choose an optical disc 1 to rent or buy. Alternatively, the customer 230 may order the optical disc 1, for example, by phone or via the Internet. When the customer 230 inserts the disc 1 in the optical disc player 231, the customer can watch the video, listen to the audio and play the game on the disc 1. In the system according to the invention, the optical disc player 231 has a connection to the Internet 240, possibly through a personal computer (PC), 232. Via the Internet 240 connection, the customer 230 can visit a website of the rental chain or retailer 220. The website is hosted from a web server 223, which may be located in the shop from which the disc 1 is rented or bought. The shop preferably comprises a computer 222 to allow connection to the website or the web server 223 as part of the computer 222 in the shop. Alternatively, the website is hosted from a central web server (not shown) outside the shop and the computer 222 in the shop is connected to the central web server through the Internet 240. The web server may be coupled to a customer database of the rental chain or retailer 220 to provide customer-related information. The services offered by the website depend on the bar code 5 on the BCA 3 of the optical disc 1 in the optical disc player 231, such that additional services may be provided to the customer 230 when a disc 1 originating from the rental chain or retailer 220 is in the optical disc player 231. The additional services may also depend on the content stored on the pre-recorded area 2 of the optical disc 1.

FIG. 4 schematically shows the process of visiting a website of the rental chain or retailer 220. In a first step INT, the customer 230 decides to connect to the Internet 240 and does so by e.g. pressing an Internet button on a remote control or on the player 231 for activating an Internet browser application on the player 231 or by starting an Internet browser application on the PC 232. Optionally, the system automatically takes this decision, for example, after having detected that the code on a record carrier loaded by the user includes an Internet address. In the following step GWR, the customer 230 chooses an Internet address of the website of a rental chain or retailer 220 to navigate to by e.g. typing the address or choosing the address from a list. If the bar code 5 includes a URL or IP address, the Internet browser application may automatically navigate to the website. The browser application may also automatically navigate to a central server which automatically redirects the customer to the website depending on the bar code 5. After navigating to the website, the web server 223 sends a request to the (e.g. optical disc) player 231, or the PC 232, for sending the bar code 5 on the BCA 3 to the web server 223 in a subsequent step GBCA. Alternatively, the bar code 5 is already sent to the web server 223 when navigating to the website. In the next step CBCA, the bar code 5 is checked by the web server 223. If the web server 223 recognizes the bar code 5, additional services are provided to the customer 230 in a subsequent step SERV+. Such additional services may comprise the offering of background information about a movie, additional content (e.g. deleted scenes, bloopers, etc.) special offers for renting or buying other optical discs and much more. If the web server 223 does not recognize the bar code 5, only some standard, publicly available services may be offered in a process step SERV.

In a preferred embodiment, the web server 223 does not only check the BCA 3 of the record carrier 1, but also checks the identity of the customer 230 and the data content of the optical disc 1. Several techniques are suitable for identifying the customer 230. The customer 203 may provide a user name and password for authentication, a user name and password may be stored in the player 231 or PC 232 as a cookie, or a chip card may be inserted in a chip card reader connected to the player 231 or PC 232. If the customer 230 has a membership account at the rental chain or retailer 220, additional membership-related services may be provided. Examples of such membership-related services are showing a list of record carriers (e.g. optical discs) which the customer 230 has rented or bought in the past, showing suggestions of record carriers to rent or buy depending on the optical discs on the list, offering the possibility to make a reservation for popular record carriers or record carriers that have not yet been released, and much more. The web server may also check the data content of the record carrier 1 and offer services related to this data content. A title or serial number of the record carrier 1 may be coded on the BCA 3 additionally to the code identifying the rental chain or retailer 220, or the record carrier 1 may be recognized on the basis of data on the data area 2 of the record carrier 1. Services related to the data content may include providing links to websites with information about the content of the optical disc, providing a discussion forum, where customers 230 can give their opinion concerning the optical disc, providing a list of movies which are directed by the same director as a movie on the record carrier, and much more.

It will be appreciated that the invention can also be extended to computer programs, particularly computer programs on or in a carrier, adapted to put the invention into practice. The program may be in the form of a source code, an object code, a code intermediate source and object code such as a partially compiled form, or in any other form suitable for use in the implementation of the method according to the invention. The carrier may be any entity or device capable of carrying the program. For example, the carrier may include a storage medium, such as a ROM, for example, a CD ROM or a semiconductor ROM, or a magnetic recording medium, for example, a floppy disc or hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for rendering content pre-recorded on a record carrier and for accessing associated data, including:
a first storage (223) for storing data associated with a same content stored in a pre-recorded area of a plurality of record carriers;
a second storage (223) for associating data stored in the first storage with at least one code;
a reading device (231) including:
means (433) for receiving a record carrier including a pre-recorded area and a write-once area,
means (436) for reading content stored in the pre-recorded area of the received record carrier for rendering;
means (435) for reading a code stored in the write-once area of the received record carrier; and
means (434) for accessing data stored in the first storage
the system, based on information stored in the second storage, being operative to verify whether the read code corresponds to a code associated with data in the first storage and to grant the reading device access to data stored in the first storage only upon a positive verification.

2. A system as claimed in claim 1, wherein the first storage is located in a storage device accessible through a wide area network (240).

3. A system as claimed in claim 2, wherein the code includes an identification of a location in the network of the storage device and/or the data in the storage device.

4. A system as claimed in claim 2, wherein the system includes an interface for receiving an identification of a location in the network of the storage device and/or the data in the storage device.

5. A system as claimed in claim 3, wherein the identification of a location in the network includes a universal resource locator (URL) and/or IP address.

6. A system as claimed in claim 1, wherein the code is distinct for respective suppliers of the record carrier and the same for record carriers with a same pre-recorded content and supplied by a same supplier.

7. A system as claimed in claim 1, wherein the code includes a unique identification of the record carrier.

8. A system as claimed in claim 1, wherein the pre-recorded area of the record carrier includes an application program executable by the reading device for performing the verification whether the read code corresponds to a code associated with data in the first storage.

9. A system as claimed in claim 2, wherein the system includes an interface for receiving an identity of a user; the storage device including a database for storing user data in association with an identity of a user; the system being operative to grant the reading device access to user data in the database that is associated with the received user identity only upon the verification being positive.

10. A system as claimed in claim 1, wherein the reading device includes a user interface for enabling a user to set a parental control level;
the first storage being arranged to store, in association with the stored data, an indication of at least one acceptable parental control level; and
the system being operative to verify whether the parental control level set by the user is an acceptable parental control level according to the indication associated with the data in the storage and to grant the reading device access to data stored in the first storage only upon a positive verification of the parental control level.

11. A system as claimed in claim 1, wherein the record carrier is of an optical storage type and the write-once area is a burst cutting area.

12. A reading device (231) for use in the system as claimed in claim 1, wherein a first storage stores data associated with content stored in a pre-recorded area of a record carrier; and a second storage stores information for associating data stored in the first storage with at least one code; the reading device including:
means (433) for receiving a record carrier,
means (436) for reading content stored in a pre-recorded area of the received record carrier for rendering;
means (435) for reading a code stored in a write-once area of the received record carrier;
means (434, 437) for obtaining information stored in the second storage and, based on the obtained information, verifying whether the read code corresponds to a code associated with data in the first storage; and, upon a positive verification, accessing data stored in the first storage.

13. A reading device (231) for use in the system as claimed in claim 1, wherein a storage device in the system stores data associated with content stored in a pre-recorded area of a record carrier; the storage device being accessible through a wide area network and being operative to verify whether a code supplied through the network corresponds to at least one code associated with data in the storage device, and, upon a positive verification, grants a device that supplied the code access to data stored in the storage device; the reading device including:
means (433) for receiving a record carrier,
means (436) for reading content stored in a pre-recorded area of the received record carrier for rendering;
means (435) for reading a code stored in a write-once area of the received record carrier;
means (434, 437) for supplying, through the network, the read code to the storage device, requesting access to data in the storage device and, upon access being granted, accessing the data.

14. A method of rendering content pre-recorded on a record carrier and of accessing data in a first storage, which data is associated with the pre-recorded content; the method comprising the steps of:
reading content stored in a pre-recorded area of a record carrier for rendering;
reading a code stored in a write-once area of the record carrier; and
verifying whether the read code corresponds to a code associated with data in the first storage and granting access to data stored in the first storage only upon a positive verification.

15. A computer program product for causing a processor to perform the method of claim 14.
